(19) United States
(12) Patent Application Publication
(10) Pub. No.: US 2014/0147228 A1
(43) Pub. Date: May 29, 2014

(54) CONNECTOR WITH BOLT

(71) Applicant: Naoki Kobayashi, Toyota-shi (JP)

(72) Inventor: Naoki Kobayashi, Toyota-shi (JP)

(73) Assignee: YAZAKI CORPORATION, Tokyo (JP)

(21) Appl. No.: 14/233,177

(22) PCT Filed: Jul. 19, 2012
(86) PCT No.: PCT/JP2012/068898

§ 371 Date: Feb. 5, 2014

(30) Foreign Application Priority Data
Jul. 19, 2011 (JP) 2011-158287

(51) Int. Cl. F16B 31/02

(52) U.S. Cl. CPC F16B 31/02
USPC 411/103

(57) ABSTRACT

A connector with bolt includes a first and second housings, a nut, bolt, and spring. The bolt is movable between a first position, which is a position of a tip of a threaded part of the bolt at a time when the tip of the threaded part is in contact with one end of the nut, and a second position, which is a position of the tip at a time when the threaded part having passed through the nut is idly revolvable. The spring has an elastic property set such that, when fitting of the first and second housings is completed by tightening of the bolt and the nut, the bolt moves to a middle between the first and second positions and a reaction force of the spring that is compressed by the movement of the bolt raises a torque for the tightening to a specified value.

### TECHNICAL FIELD

The present invention relates to a connector with bolt in which, at the time of mutual fitting connection of housings that form a pair with each other, a bolt provided in one housing is screwed into a nut provided and fixed to the other housing so that mutual fitting connection of the housings is achieved.

### BACKGROUND ART

FIG. 9 shows a related-art example of a connector with bolt.

The connector 100 with bolt shown here is disclosed in the following PLT 1. Then, at the time of mutual fitting connection of a pair of male and female housings 110 and 120 that form a pair with each other, a bolt 130 provided in one housing constructed as the female housing 110 is screwed into the nut 140 provided and fixed to the other housing constructed as the male housing 120 so that mutual fitting connection of the housings 110 and 120 is achieved.

In the bolt 130 provided in the female housing 110, a male threaded part 135 is provided at the tip. Then, the bolt 130 is inserted through a bolt insertion hole 111 formed in the female housing 110. In the bolt 130 attached to the bolt insertion hole 111, its movable range is restricted by a snap ring 131 and a bolt urging spring 132.

The snap ring 131 abuts against a peripheral part 111a of a tip-side opening of the bolt insertion hole 111 so as to prevent the bolt 130 from falling out of the bolt insertion hole 111. Further, the bolt urging spring 132 urges the bolt 130 toward a direction of escaping from the bolt insertion hole 111, so as to maintain the snap ring 131 in a state of abutting against the peripheral part 111a.

FIG. 9 shows a state that the housings 110 and 120 abut against each other at a fitting start position. In this state, the tip of the male threaded part 135 of the bolt 130 is in contact with the nut 140 in a screwing-permitting manner. Then, when the bolt 130 is revolved in a tightening direction, screwing of the bolt 130 into the nut 140 progresses and mutual fitting of the housings 110 and 120 goes further.

In this related-art connector 100 with bolt, the length and the movable range of the bolt 130 are set up such that in a state that mutual fitting of the housings 110 and 120 has been completed normally, the male threaded part 135 has passed through the nut 140 and the bolt 130 revolves idly.

### CITATION LIST

### Patent Literature

[PTL 1] JP-A-11-339884

### SUMMARY OF INVENTION

### Technical Problem

Meanwhile, for example, in a case that the above-mentioned connector 100 with bolt is installed on a vehicle, from the perspective of assembling workability and the like, an impact wrench is frequently used in the operation of tightening the bolt 130 for achieving mutual fitting connection of the housings 110 and 120.

Nevertheless, in such tightening work employing an impact wrench, an impact power generated by the impact wrench itself makes it difficult to recognize a feeling change that occurs when the bolt 130 becomes idly revolvable.

Thus, the impact wrench cannot be separated from the bolt 130 immediately after mutual fitting of the housings 110 and 120 has been completed normally. Thus, the bolt 130 is continued to be revolved idly, and hence a possibility arises that the sliding friction of the bolt 130 causes damage such as heating deformation in the peripheral part of the bolt insertion hole 111.

It is therefore one advantageous aspect of the present invention to provide a connector with bolt that realizes a situation that the tightening work for the bolt necessary for mutual fitting connection of the housings is achieved by using an impact wrench easily and safely without causing damage in the housings.

### Solution to Problem

According to one advantage of the invention, there is provided a connector with bolt comprising: a first housing formed with an insertion hole; a second housing; a nut fixed in the second housing; a bolt provided in the insertion hole and having a threaded part, the bolt configured to be screwed into the nut so that the first and second housings are fitted to each other, the bolt being movable between a first position and a second position, the first position which is a position of a tip of the threaded part of the bolt at a time when the tip of the threaded part is in contact with one end of the nut, the second position which is a position of the tip of the threaded part of the bolt at a time when the threaded part having passed through the nut is idly revolvable; and a spring configured to urge the bolt toward a direction in which the bolt escapes from the insertion hole, the spring having an elastic property set such that, when fitting of the first and second housings is completed by tightening of the bolt and the nut, the bolt moves to a middle between the first and second positions and a reaction force of the spring that is compressed by the movement of the bolt raises a torque for the tightening to a specified value.

### Advantageous Effects of Invention

According to an aspect of the invention, at the time that mutual fitting of the housings has normally been completed by tightening of the bolt and the nut, the tightening torque for the bolt has been raised to a specified value. Thus, in a case that an impact wrench whose maximum driving torque is set at the above-mentioned specified value is used as a tool for the operation of tightening the bolt, the torque transmission operation for the bolt is terminated at the time that the driving torque reaches the specified value. Accordingly, on the basis of the termination of operation of the impact wrench, the operator immediately recognizes the timing of completion of mutual fitting of the housings.

Further, in a state that mutual fitting of the housings has been completed normally, the male threaded part of the bolt is screwed into the nut and hence the bolt is not allowed to revolve idly. Thus, a situation is avoided that the friction of sliding of the idly revolving bolt causes damage such as heating deformation in the peripheral part of the bolt insertion hole of the one housing.

Thus, the tightening work for the bolt necessary for mutual fitting connection of the housings is achieved by using an impact wrench easily and safely without causing damage in the housings.

### BRIEF DESCRIPTION OF DRAWINGS

FIG. 1 is an exploded perspective view a connector with bolt according to an embodiment of the present invention.

FIG. 2 is an exploded perspective view of a female housing shown in FIG. 1.

FIG. 3 is a perspective view of a female housing shown in FIG. 1, viewed from the tip side.

FIG. 4 is a sectional view taken along line A-A in FIG. 3.

FIG. 5 is a perspective view of a male housing shown in FIG. 1, viewed from the tip lower side.

FIG. 6 is a sectional view taken along line B-B in FIG. 5.

FIGS. 7(a), 7(b) and 7(c) are explanation diagrams showing the steps of mutual fitting connection for a pair of housings according to an embodiment. FIG. 7(a) is a vertical sectional view showing a state that housings are separated and opposite to each other. FIG. 7(b) is a vertical sectional view showing a state that housings abut against each other at a fitting start position. FIG. 7(c) is a vertical sectional view showing a state that tightening of a bolt is on going and housings are in the course of mutual fitting.

FIGS. 8(a) and 8(b) are explanation diagrams showing the steps of mutual fitting connection for a pair of housings according to an embodiment. FIG. 8(a) is a vertical sectional view showing a state that a tightening torque for a bolt has reached a specified value and mutual fitting of housings has been completed normally. FIG. 8(b) is a vertical sectional view showing a state that a bolt has been tightened with a driving torque exceeding a specified value so that the male threaded part of the bolt has passed through a nut and has become idly revolvable.

FIG. 9 is a vertical sectional view showing a configuration of a related-art connector with bolt.

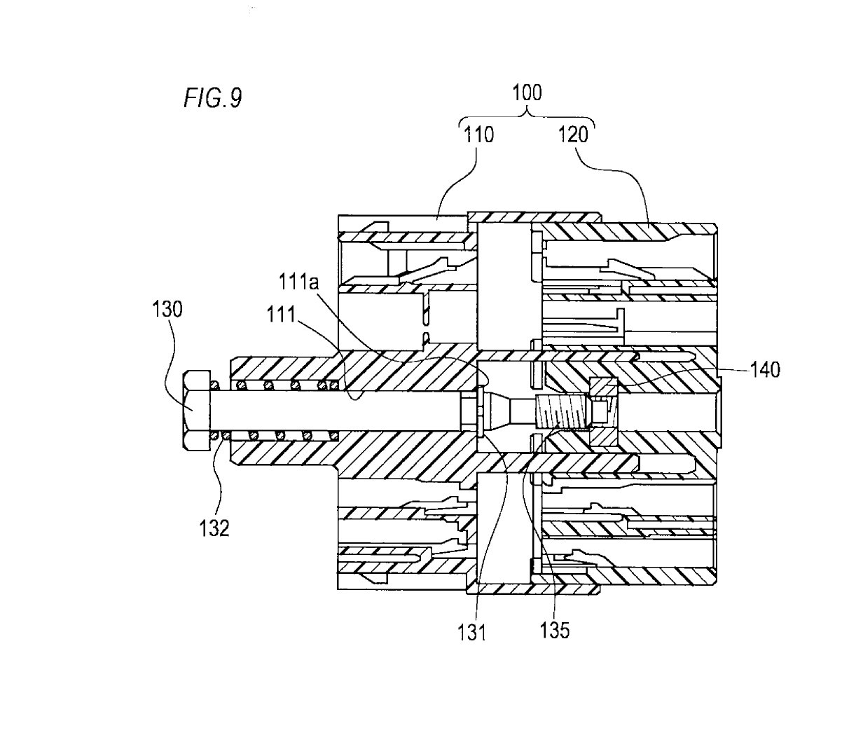

### DESCRIPTION OF EMBODIMENTS

A preferred embodiment of a connector with bolt according to the present invention is described below in detail with reference to the drawings.

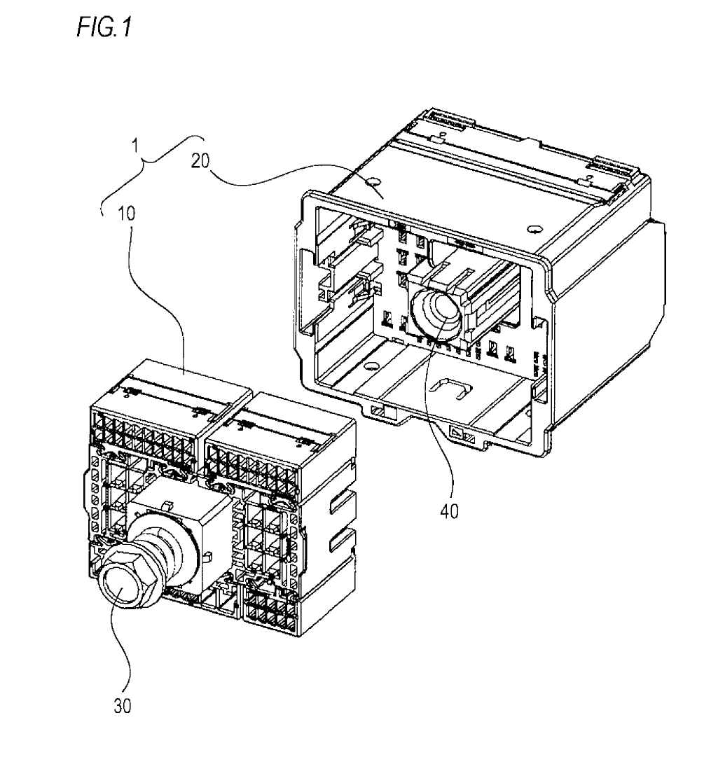

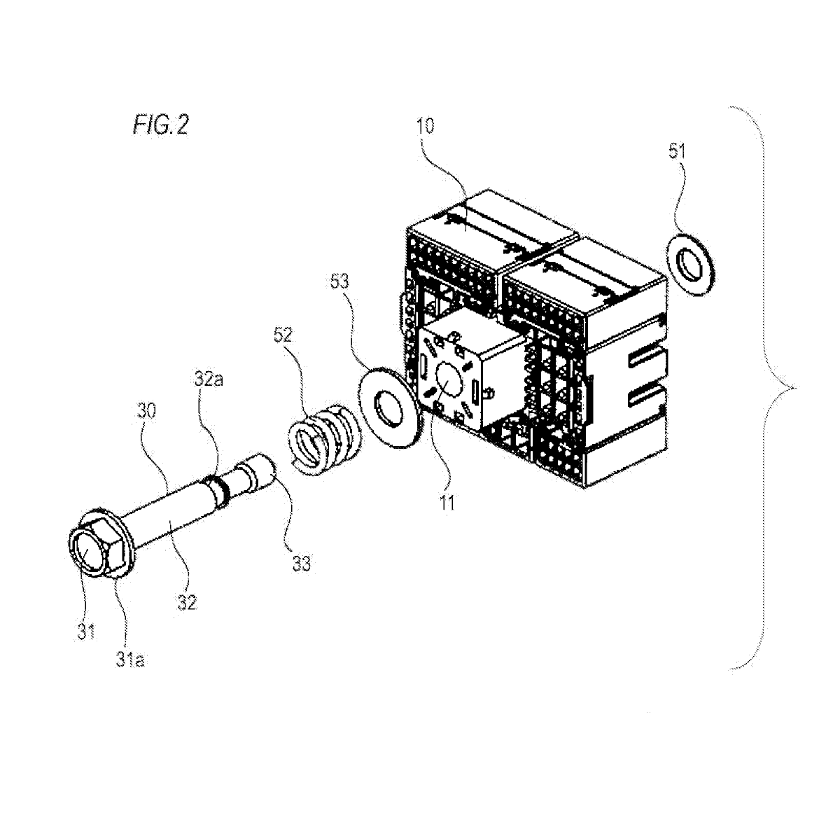

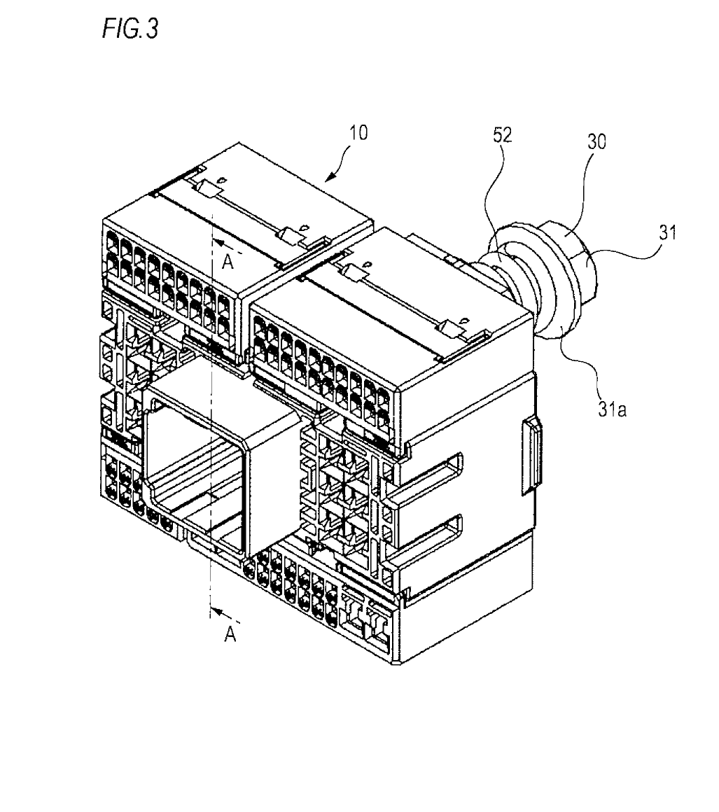

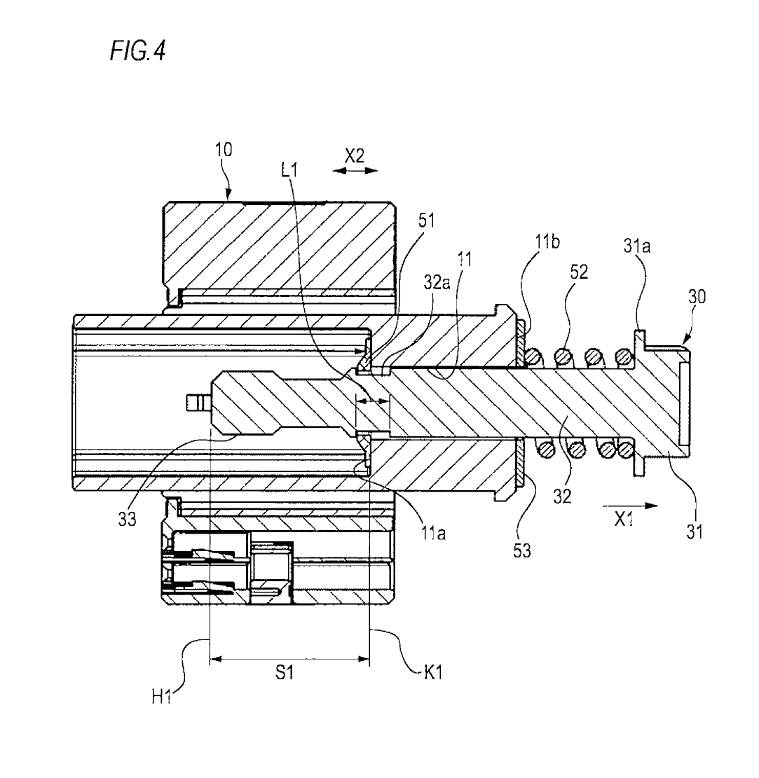

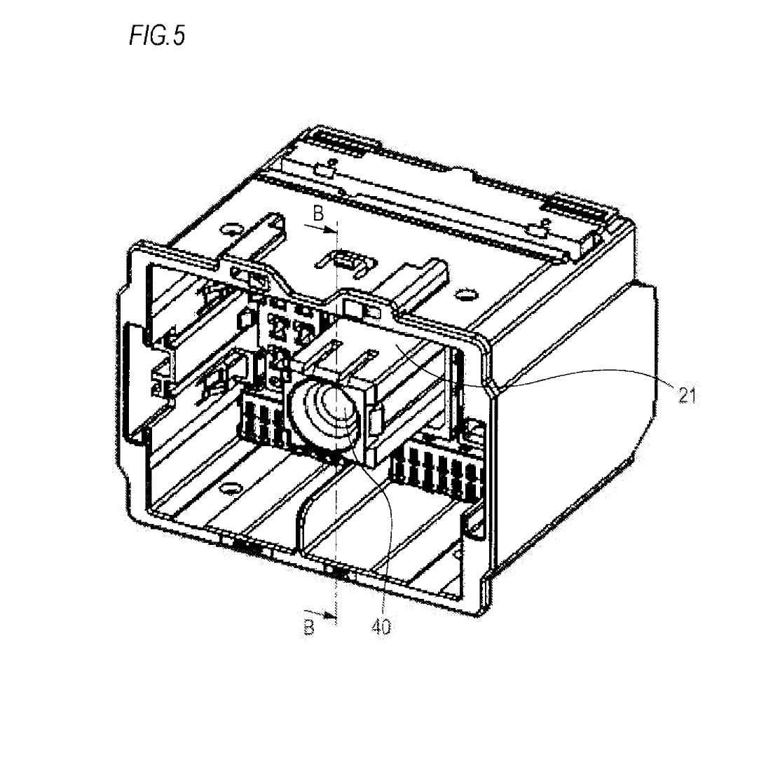

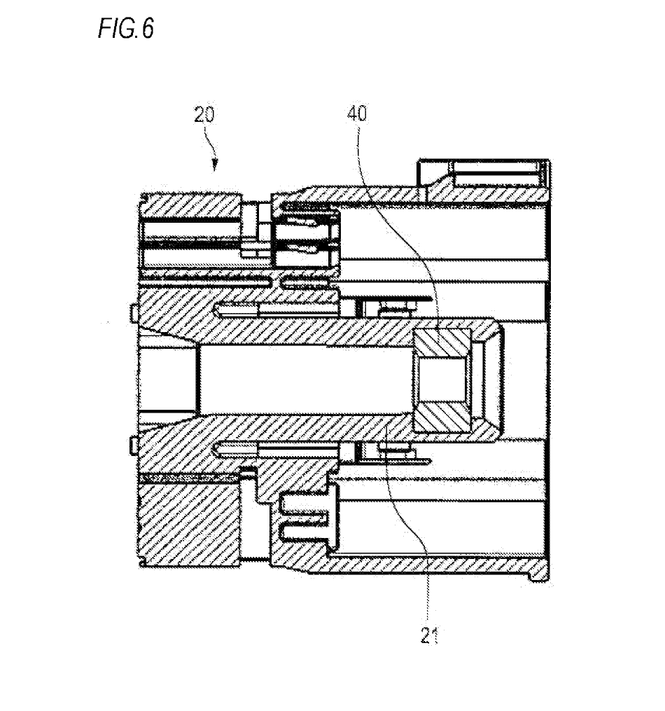

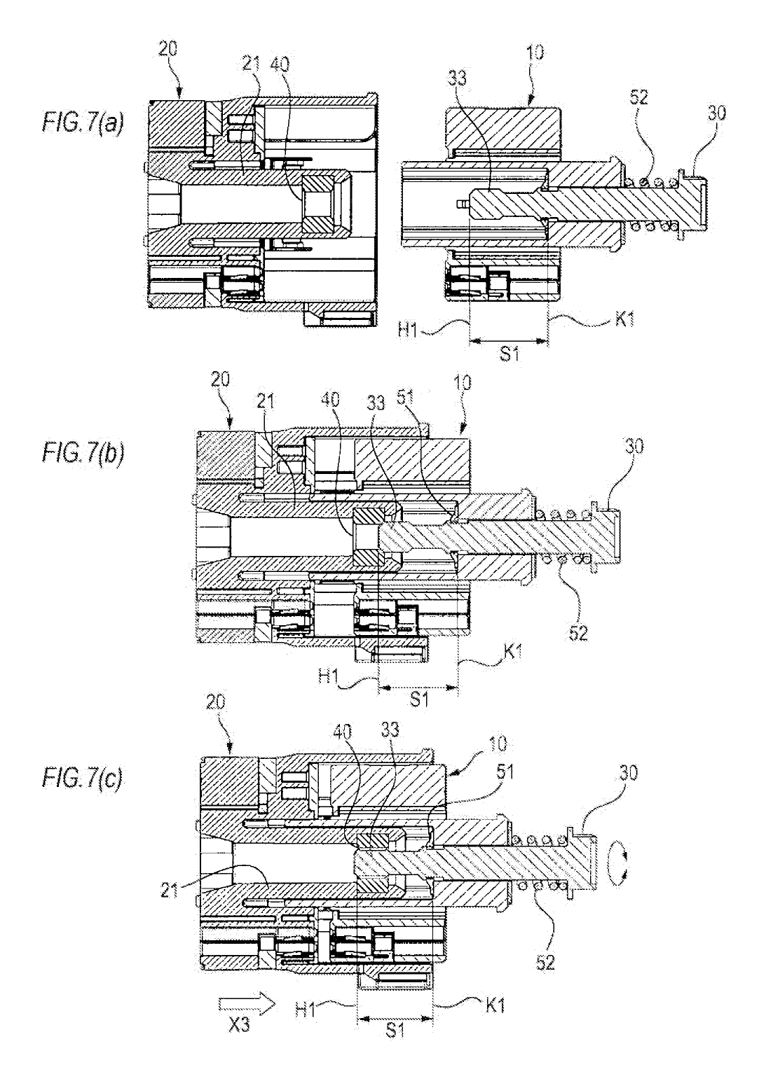

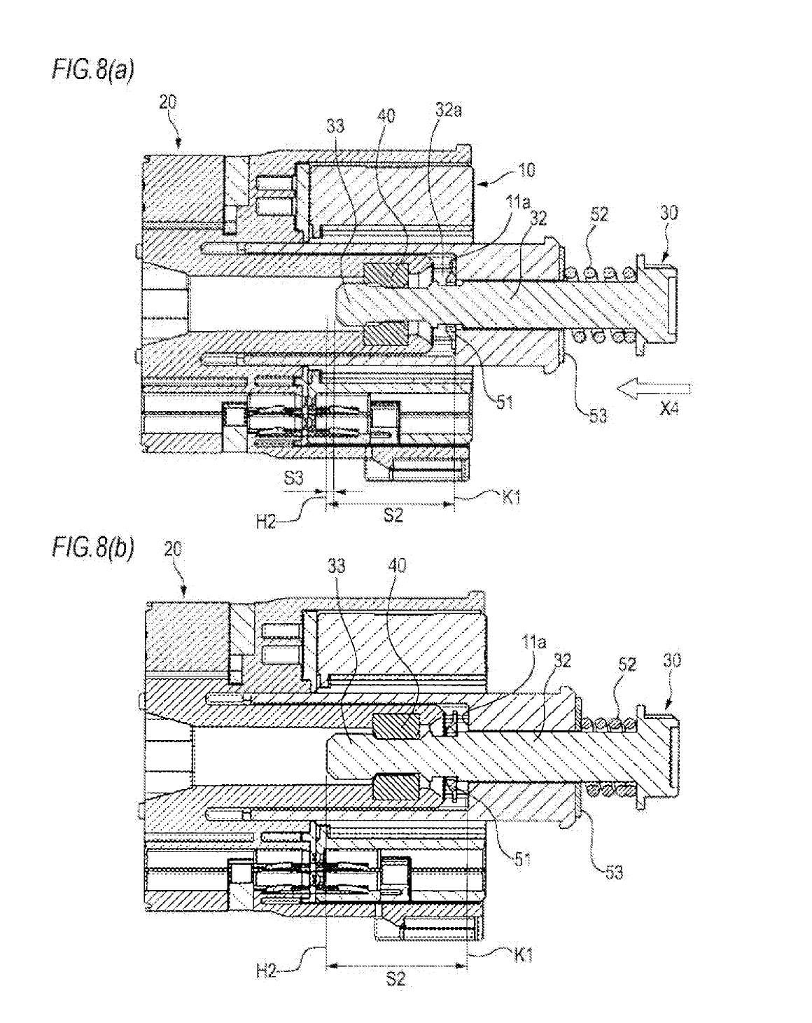

FIGS. 1 to 8(b) show an embodiment of a connector with bolt according to the present invention. FIG. 1 is an exploded perspective view of a connector with bolt according to an embodiment. FIG. 2 is an exploded perspective view of a female housing shown in FIG. 1. FIG. 3 is a perspective view of the female housing shown in FIG. 1, viewed from the tip side. FIG. 4 is a sectional view taken along line A-A in FIG. 3. FIG. 5 is a perspective view of the male housing shown in FIG. 1, viewed from the tip lower side. FIG. 6 is a sectional view taken along line B-B in FIG. 5. FIGS. 7(a), 7(b) and 7(c) are explanation diagrams showing the steps of mutual fitting connection for a pair of housings according to an embodiment. FIG. 7(a) is a vertical sectional view showing a state that the housings are separated and opposite to each other. FIG. 7(b) is a vertical sectional view showing a state that the housings abut against each other at a fitting start position. FIG. 7(c) is a vertical sectional view showing a state that tightening of a bolt is on going and the housings are in the course of mutual fitting. Further, FIGS. 8(a) and 8(b) are explanation diagrams showing the steps of mutual fitting connection for a pair of housings according to an embodiment. FIG. 8(a) is a vertical sectional view showing a state that a tightening torque for a bolt has reached a specified value and mutual fitting of the housings has been completed normally. FIG. 8(b) is a vertical sectional view showing a state that the bolt has been tightened with a driving torque exceeding a specified value so that the male threaded part of the bolt has passed through a nut and has become idly revolvable.

In the connector 1 with bolt according to this embodiment, at the time of mutual fitting connection of a pair of male and female housings 10 and 20 that form a pair with each other, a bolt 30 provided in one housing constructed as the female housing 10 is screwed into the nut 40 provided and fixed to the other housing constructed as the male housing 20 so that fitting connection of the housings 10 and 20 is achieved.

As shown in FIG. 2, the bolt 30 provided in the female housing 10 includes: a head 31 in which a flange 31a serving as a spring seat is formed integrally; a shaft 32 extending from the head 31; and a male threaded part 33 located at the tip of the shaft 32. As shown in FIGS. 2 and 4, the bolt 30 is inserted through a bolt insertion hole 11 formed in the female housing 10. The bolt 30 attached to the bolt insertion hole 11 is held in the bolt insertion hole 11 by a snap ring 51 and a bolt urging spring 52 attached to the bolt 30, in a manner of being movable in the axis directions between a screwing start position H1 and a nut passing position H2 which are described later.

As shown in FIG. 4, the snap ring 51 is fit and attached to a small diameter part 32a for ring attachment formed in the shaft 32 of the bolt 30. As shown in FIG. 4, the small diameter part 32a extends in the range of length L1 along the axis directions of the shaft 32. The length L1 is set up greater than the plate thickness of the snap ring 51. Thus, the snap ring 51 is fit in a manner permitting sliding in the axis directions (the arrow X2 directions in FIG. 4). As shown in FIG. 4, the snap ring 51 described above abuts against the peripheral part 11a of the opening on the tip side (the left-end side in FIG. 4) of the bolt insertion hole 11 so as to prevent the bolt 30 from falling out of the bolt insertion hole 11.

The bolt urging spring 52 is composed of a helical compression spring. As shown in FIG. 4, the bolt urging spring 52 is attached in a compressed state between a flat washer 53 abutting against the peripheral part 11b of the opening on the rear-end side (on the right end side in FIG. 4) of the bolt insertion hole 11 and the flange 31a of the head 31 of the bolt 30. As shown in FIG. 4, the bolt urging spring 52 urges the bolt 30 toward a direction (the arrow X1 direction in FIG. 4) of escaping from the bolt insertion hole 11, so as to maintain the snap ring 51 in a state of abutting against the peripheral part 11a.

The elastic property of the bolt urging spring 52 is described later.

The snap ring 51 and the bolt urging spring 52 restrict the movable range of the bolt 30 on the female housing 10 into a range from a screwing start position H1 to a nut passing position H2 described later.

As shown in FIG. 4, the screwing start position H1 is the position of the tip of the male threaded part 33 at the time when the snap ring 51 abutting against the peripheral part 11a displaces the bolt 30 to the maximum toward a direction (the arrow X1 direction in FIG. 4) of falling out. In other words, the screwing start position H1 is defined as the position of the tip of the male threaded part 33 of the bolt 30, relative to a reference surface K1 on the female housing 10, at the time when the tip of the male threaded part 33 becomes in contact with the nut 40 (one end of the nut 40) in a screwing-permitting manner in a state that the housings 10 and 20 abut against each other at the fitting start position as shown in FIG. 7(b). In more detailed description, in the present embodiment, as shown in FIG. 4, the reference surface K1 is located at the peripheral part 11a of the tip-side opening of the bolt insertion hole 11 against which the snap ring 51 abuts. Then, as shown in FIG. 4, the distance from the reference surface K1 to the tip of the male threaded part 33 at the time that the bolt 30 is located at the screwing start position H1 is denoted by S1.

As shown in FIG. 8(b), the nut passing position H2 is the position of the tip of the male threaded part 33 of the bolt 30, relative to the reference surface K1, at the time when the male threaded part 33 of the bolt 30 has passed through the nut 40 in the male housing 20 and has become idly revolvable in a state that mutual fitting of the housings 10 and 20 has been completed normally. As shown in FIG. 8(b), the distance from the reference surface K1 to the tip of the male threaded part 33 at the time that the bolt 30 has moved to the nut passing position H2 is denoted by S2.

As shown in FIG. 6, the male housing 20 has a tube part 21 into which the bolt 30 is inserted. Then, the tube part 21 is provided with the nut 40 into which the bolt 30 is screwed. The nut 40 is provided and fixed to the tube part 21 by insert molding.

Next, the elastic property of the bolt urging spring 52 is described below.

As shown in FIG. 8(a), the elastic property of the bolt urging spring 52 is set up such that at the time that mutual fitting of the housings 10 and 20 has normally been completed by tightening of the bolt 30 and the nut 40, the bolt 30 has moved to the middle between the screwing start position H1 and the nut passing position H2 so that the reaction force of the bolt urging spring 52 compressed by the movement has raised the tightening torque for the bolt 30 to a specified value.

Next, the change of position of the bolt 30 during the steps of mutual fitting connection of the pair of housings 10 and 20 is performed by using an impact wrench is described below in the order of process steps.

As shown in FIG. 7(a), in the female housing 10 in a state of being separated from the male housing 20, the tip position of the male threaded part 33 of the bolt 30 is maintained at the screwing start position H1.

Then, as shown in FIG. 7(b), the mutual housings 10 and 20 abut against each other at the fitting start position. In this state, the tip position of the male threaded part 33 of the bolt 30 is maintained at the screwing start position H1, and the tip of the male threaded part 33 is in contact with the nut 40 in a screwing-permitting manner. Thus, in this state, when the bolt 30 is revolved with an impact wrench in a tightening direction, the male threaded part 33 is screwed into the nut 40.

FIG. 7(c) shows a middle state in the fitting course that the operation of tightening the bolt 30 is started from the state of FIG. 7(b) and screwing of the bolt 30 into the nut 40 is on-going. In this state where fitting of the pair of housings 10 and 20 is in a middle state, in association with the operation of tightening the bolt 30, the male housing 20 formed integrally with the nut 40 moves in the arrow X3 direction so that mutual fitting of the pair of housings 10 and 20 goes further.

FIG. 8(a) shows a state that the bolt 30 has been revolved in the tightening direction further from the state of FIG. 7(c) so that mutual fitting of the pair of housings 10 and 20 has been completed normally. In this state, the mutual movement of the pair of housings 10 and 20 is restricted in the direction that their end faces abut against each other and fitting goes further. Thus, when revolution in the tightening direction is imparted to the bolt 30, the bolt 30 is displaced in the arrow X4 direction relative to the female housing 10.

In the state that mutual fitting of the pair of housings 10 and 20 has been completed normally as shown in FIG. 8(a), the snap ring 51 has moved to the rear-end side on the small diameter part 32a and the position of the tip of the male threaded part 33 has moved in the middle between the screwing start position H1 and the nut passing position H2. Further, the reaction force of the bolt urging spring 52 compressed by the movement of the bolt 30 has raised the tightening torque for the bolt 30 to a specified value. Thus, the bolt 30 cannot further be tightened by using an impact wrench whose driving torque is set at the specified value. Thus, when tightening operation by using an impact wrench has been completed and further tightening has become unachievable, the operator immediately recognizes the timing of completion of mutual fitting of the housings 10 and 20.

In a case that as a result of erroneous setting or the like for the driving torque of the impact wrench, the actually set-up driving torque of the impact wrench exceeds the above-mentioned specified value, the bolt 30 can be revolved in the tightening direction further from the state of FIG. 8(a). In this case, with compressing the bolt urging spring 52, the bolt 30 moves in a spiral manner on the nut 40. Then, as shown in FIG. 8(b), movement of the bolt 30 stops at a position that the male threaded part 33 has passed through the nut 40 and has become idly revolvable. In this state that the male threaded part 33 is idly revolvable, the tip of the male threaded part 33 is located at the nut passing position H2.

Thus, even when the bolt 30 is revolved with an excessive driving torque, the press load acting between the pair of housings 10 and 20 abutting against each other does not exceed the compressive load of the bolt urging spring 52 obtained when the bolt 30 reaches the nut passing position H2. Thus, a situation is avoided that the housings 10 and 20 are damaged by the excessive load.

In the connector 1 with bolt according to an embodiment described above, as shown in FIG. 8(a), at the time that mutual fitting of the housings 10 and 20 has normally been completed by tightening of the bolt 30 and the nut 40, the reaction force of the compressed bolt urging spring 52 has raised the tightening torque for the bolt 30 to a specified value.

Thus, in a case that an impact wrench whose maximum driving torque is set at the above-mentioned specified value is used as a tool for the operation of tightening the bolt 30, the torque transmission operation for the bolt 30 is terminated at the time that the driving torque reaches the specified value. Accordingly, on the basis of the termination of operation of the impact wrench, the operator immediately recognizes the timing of completion of mutual fitting of the housings 10 and 20.

Further, in a state that mutual fitting of the housings 10 and 20 has been completed normally, as shown in FIG. 8(a), the male threaded part 33 of the bolt 30 is screwed into the nut 40 and hence the bolt 30 is not allowed to revolve idly. Thus, a situation is avoided that the friction of sliding of the idly revolving bolt 30 causes damage such as heating deformation in the peripheral part of the bolt insertion hole 11 of the one housing 10.

Thus, the tightening work for the bolt 30 necessary for mutual fitting connection of the housings 10 and 20 is achieved by using an impact wrench easily and safely without causing damage in the housings 10 and 20.

Here, the connector 1 with bolt according to the present invention is not limited to any embodiment described above, and appropriate modifications, improvements, and the like may be applied.

For example, as for the reference surfaces serving as references for the screwing start position H1 and the nut passing position H2 for the bolt 30, the peripheral part 11b of the rear-end side opening may be adopted in place of the peripheral part 11a of the tip-side opening of the bolt insertion hole 11.

The present application is based on Japanese Patent Application No. 2011-158287 filed on Jul. 19, 2011, the contents of which are incorporated herein by way of reference.

### REFERENCE SIGNS LIST

1 connector with bolt
10 female housing
11a peripheral part (reference surface)
20 male housing
30 bolt
40 nut
51 snap ring
52 bolt urging spring
H1 screwing start position
H2 nut passing position

1. A connector with bolt comprising:
a first housing formed with an insertion hole;
a second housing;
a nut fixed in the second housing;
a bolt provided in the insertion hole and having a threaded part, the bolt configured to be screwed into the nut so that the first and second housings are fitted to each other, the bolt being movable between a first position and a second position, the first position which is a position of a tip of the threaded part of the bolt at a time when the tip of the threaded part is in contact with one end of the nut, the second position which is a position of the tip of the threaded part of the bolt at a time when the threaded part having passed through the nut is idly revolvable; and
a spring configured to urge the bolt toward a direction in which the bolt escapes from the insertion hole, the spring having an elastic property set such that, when fitting of the first and second housings is completed by tightening of the bolt and the nut, the bolt moves to a middle between the first and second positions and a reaction force of the spring that is compressed by the movement of the bolt raises a torque for the tightening to a specified value.
